(19) United States
(12) Patent Application Publication
(10) Pub. No.: US 2015/0242370 A1
(43) Pub. Date: Aug. 27, 2015

(54) METHOD AND APPARATUS FOR PROCESSING DATA

(71) Applicant: Samsung Electronics Co., Ltd., Suwon-si (KR)

(72) Inventors: Woon-Yong SEO, Suwon-si (KR); Se-Jun SONG, Seoul (KR); Ji-Young KIM, Suwon-si (KR)

(21) Appl. No.: 14/631,229

(22) Filed: Feb. 25, 2015

(30) Foreign Application Priority Data
Feb. 26, 2014 (KR) 10-2014-0022551

(51) Int. Cl. G06F 17/21; G06F 17/22

(52) U.S. Cl. CPC G06F 17/211; G06F 17/2247; G06F 17/2264

(57) ABSTRACT

An apparatus and a method for controlling an electronic device are provided. The method includes executing a first program, providing first clip data based on the first program, converting the first clip data into second clip data associated with a second program, and processing the second clip data based on the second program.

### CROSS-REFERENCE TO RELATED APPLICATION(S)

This application claims the benefit under 35 U.S.C. §119(a) of a Korean patent application filed on Feb. 26, 2014 in the Korean Intellectual Property Office and assigned Serial number 10-2014-0022551, the entire disclosure of which is hereby incorporated by reference.

### TECHNICAL FIELD

The present disclosure relates to an electronic device. More particularly, the present disclosure relates to a method and an apparatus for controlling an electronic device which provides a clipboard function.

### BACKGROUND

Recently, electronic devices complexly performing one or more functions are gradually increasing. Further, the mainstream of such electronic devices is occupied by mobile terminals represented by so-called “smart phones.” A mobile terminal is equipped with a display module of a large-screen-touch-type and has a high pixel camera module as well as the basic function for communication with a counterpart. Therefore, the mobile terminal can photograph a still image and a video. Further, the mobile terminal can reproduce multimedia contents, such as music or video, and can access a network for Web surfing. The mobile terminal as described above has a continuously evolving high performance processor and thus can perform various functions.

In general, the electronic device provides a clipboard function for copying or moving information selected in a program. The clipboard function is a function for temporarily storing information selected in a program in order to move the selected information inside the program or to another program and can be activated when a user selects a copy or cut command.

Therefore, a need exists for a method and an apparatus for controlling an electronic device which provides a clipboard function.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device that provides a clipboard function, the clipboard function can be used amongst programs between which information is compatible.

For example, the electronic devices may be operated using a plurality of operating systems having incompatible information, and the clipboard may be unable to be activated between programs operating in operating systems using incompatible information.

Another aspect of the present disclosure is to provide an apparatus and a method for converting information used in a clipboard, i.e., clip data, to be suitable for a format of a corresponding program to enable a program with another format to support the clipboard function.

Another aspect of the present disclosure is to provide an apparatus and a method for generating a tag indicating information of a program having generated clip data when an electronic device generates the clip data.

Another aspect of the present disclosure is to provide an apparatus and a method for converting clip data based on tag information in an electronic device.

In accordance with an aspect of the present disclosure, a control method of an electronic device is provided. The method includes executing a first program, providing first clip data based on the first program, converting the first clip data to second clip data associated with a second program, and processing the second clip data based on the second program.

In accordance with an aspect of the present disclosure, an electronic device is provided. The electronic device includes a memory including a clipboard for a first program, and a first program management module configured to generate clip data and a tag of the first program, and to provide the generated clip data and tag to a second program.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to an embodiment of the present disclosure;

FIG. 2 illustrates a configuration of a clipboard management module according to an embodiment of the present disclosure;

FIG. 3 illustrates an operation of a clipboard management module according to an embodiment of the present disclosure;

FIG. 4 illustrates an operation of a clipboard management module according to an embodiment of the present disclosure;

FIG. 5 illustrates an operation of a clipboard management module according to an embodiment of the present disclosure;

FIG. 6 is a flowchart illustrating an operation of an electronic device according to an embodiment of the present disclosure;

FIG. 7 is a flowchart illustrating an operation of an electronic device according to an embodiment of the present disclosure;

FIG. 8 is a flowchart illustrating an operation of an electronic device according to an embodiment of the present disclosure;

FIG. 9 is a flowchart illustrating an operation of an electronic device according to an embodiment of the present disclosure;

FIGS. 10A and 10B illustrate operations of an electronic device according to various embodiments of the present disclosure;

FIG. 11 illustrates an operation of an electronic device according to an embodiment of the present disclosure; and

FIG. 12 is a block diagram illustrating a configuration of an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

In the present disclosure, the expression “include” or “may include” refers to the existence of a corresponding function, operation, or element, and does not limit one or more additional functions, operations, or elements. In addition, as used herein, the terms “include” and/or “have” should be construed to denote existence of a certain feature, number, operation, element, component or a combination thereof, and should not be construed to exclude the existence or possible addition of one or more other features, numbers, operations, elements, components, or combinations thereof.

In addition, as used here, the expression “or” includes any or all combinations of words enumerated together. For example, the expression “A or B” may include A, may include B, or may include both A and B.

In the present disclosure, the expressions “a first”, “a second”, “the first”, “the second”, and the like may modify various elements, but the corresponding elements are not limited by these expressions. For example, the above expressions do not limit the sequence and/or importance of the corresponding elements. The above expressions may be used merely for the purpose of distinguishing one element from other elements. For example, a first user device and a second user device indicate different user devices although both of them are user devices. For example, a first element may be termed a second element, and similarly, a second element may be termed a first element without departing from the scope of the present disclosure.

When an element is referred to as being “coupled” or “connected” to any other element, it should be understood that not only the element may be directly coupled or connected to the other element, but also a third element may be interposed therebetween. Contrarily, when an element is referred to as being “directly coupled” or “directly connected” to any other element, it should be understood that no element is interposed therebetween.

The terms used in the present disclosure are only used to describe specific embodiments, and are not intended to limit the present disclosure. As used herein, the singular forms are intended to include the plural forms as well, unless the context clearly indicates otherwise.

Unless defined otherwise, all terms used herein, including technical and scientific terms, have the same meaning as those commonly understood by a person of ordinary skill in the art to which the present disclosure pertains. Such terms as those defined in a generally used dictionary are to be interpreted to have the meanings equal to the contextual meanings in the relevant field of the art, and are not to be interpreted to have ideal or excessively formal meanings unless clearly defined in the present disclosure.

An electronic device according to the present disclosure may be a device including a communication function. For example, the electronic device may include at least one of a smart phone, a tablet Personal Computer (PC), a mobile phone, a video phone, an e-book reader, a desktop PC, a laptop PC, a netbook computer, a PDA, a Portable Multimedia Player (PMP), a Moving Picture Experts Group (MPEG-1 or MPEG-2) Audio Layer 3 (MP3) player, a mobile medical device, a camera, a wearable device (e.g., a Head-Mounted-Device (HMD), such as electronic glasses, electronic clothes, an electronic bracelet, an electronic necklace, an electronic accessory, an electronic tattoo, a smart watch, and the like).

According to an embodiment of the present disclosure, an electronic device may be a smart home appliance having a communication function. The smart home appliance may include at least one of, for example, a television, a Digital Video Disk (DVD) player, an audio player, a refrigerator, an air conditioner, a cleaner, an oven, a microwave oven, a washing machine, an air purifier, a set-top box, a TV box (e.g., HomeSync™ of Samsung, Apple TV™, or Google TV™), a game console, an electronic dictionary, an electronic key, a camcorder, or an electronic frame.

According to some embodiments of the present disclosure, the electronic device may include at least one of various types of medical devices (e.g., Magnetic Resonance Angiography (MRA), Magnetic Resonance Imaging (MRI), Computed Tomography (CT), a scanning machine, ultrasonic wave device, and the like), a navigation device, a Global Positioning System (GPS) receiver, an Event Data Recorder (EDR), a Flight Data Recorder (FDR), a car infotainment device, ship electronic equipment (e.g., navigation equipment for a ship, a gyro compass and the like), avionics, a security device, an industrial or home robot, and the like.

According to some embodiments of the present disclosure, the electronic device may include at least one of furniture or a part of a building/structure, an electronic board, an electronic signature receiving device, a projector, and various types of measuring devices (e.g., a water meter, an electric meter, a gas meter, a radio wave meter, and the like) including a communication function. The electronic device according to the present disclosure may be a combination of one or more of the aforementioned various devices. Further, it is obvious to those skilled in the art that the electronic device according to the present disclosure is not limited to the aforementioned devices.

Hereinafter, an electronic device according to various embodiments of the present disclosure will be described with reference to the accompanying drawings. The term “user” used in various embodiments may refer to a person who uses an electronic device or a device (e.g., an artificial intelligence electronic device) that uses an electronic device.

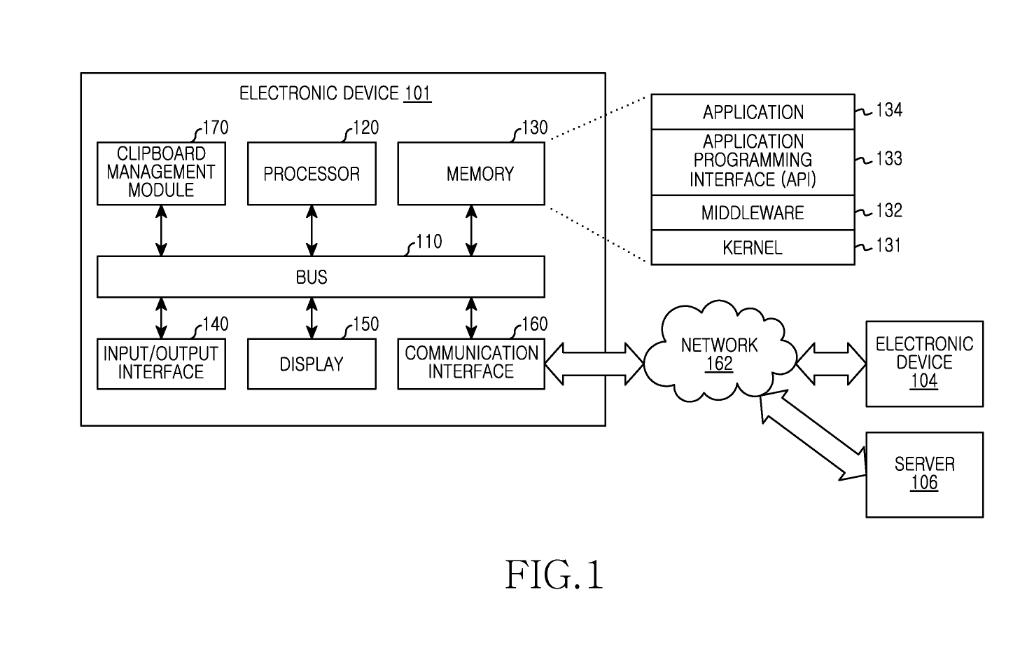

FIG. 1 illustrates a network environment including an electronic device according to an embodiment of the present disclosure.

Referring to FIG. 1, an electronic device 101 may include a bus 110, a processor 120, a memory 130, an input/output interface 140, a display 150, a communication interface 160, and a clipboard management module 170.

The bus 110 may be a circuit which interconnects the above-described elements and delivers communication (e.g., a control message) between the above-described elements.

For example, the processor 120 may receive instructions from the aforementioned other elements (e.g., the memory 130, the input/output interface 140, the display 150, the communication interface 160, and the clipboard management module 170) through the bus 110, decipher the received instructions, and perform calculation or data processing according to the deciphered instructions.

The memory 130 may store instructions or data received from or created by the processor 120 or other elements (e.g., the input/output interface 140, the display 150, the communication interface 160, and the clipboard management module 170). The memory 130 may include programming modules, such as a kernel 131, middleware 132, an Application Programming Interface (API) 133, an application 134, and the like. The aforementioned programming modules may be formed of software, firmware, hardware, or a combination of at least two thereof.

The kernel 131 may control or manage system resources (e.g., the bus 110, the processor 120, or the memory 130) used for executing an operation or a function implemented in the remaining other programming modules, for example, the middleware 132, the API 133, or the application 134. In addition, the kernel 131 may provide an interface through which the middleware 132, the API 133, or the application 134 may control or manage the individual elements of the electronic device 101 while accessing the individual elements.

The middleware 132 may perform a relay function of allowing the API 133 or the application 134 to communicate with the kernel 131 to exchange data therewith. Furthermore, in regard to task requests received from the application 134, the middleware 132 may perform a control (e.g., scheduling or load balancing) for the task requests, using a method of allocating at least one of the application 134 or a priority for using the system resources (e.g., the bus 110, the processor 120, and the memory 130) of the electronic device 101.

The API 133 is an interface through which the application 134 may control functions provided by the kernel 131 or the middleware 132, and may include at least one interface or function (e.g., an instruction) for file control, window control, image processing, or text control.

According to various embodiments of the present disclosure, the application 134 may include a Short Message Service (SMS)/Multimedia Message Service (MMS) application, an e-mail application, a calendar application, an alarm application, a health care application (e.g., an application for measuring an amount of exercise or blood sugar), and an environmental information application (e.g., an application for providing an atmospheric pressure, humidity, temperature, and the like). Additionally or alternately, the application 134 may be an application related to the exchange of information between the electronic device 101 and an external electronic device (e.g., another electronic device 104). The application related to the exchange of information may include, for example, a notification relay application for transferring particular pieces of information to the external electronic device or a device management application for managing the external electronic device.

For example, the notification relay application may include a function of transferring, to the external electronic device (e.g., the other electronic device 104), notification information generated in other applications of the electronic device 101 (e.g., an SMS/MMS application, an e-mail application, a health management application, an environmental information application, and the like). Additionally or alternatively, the notification relay application may receive notification information from, for example, the external electronic device (e.g., the other electronic device 104) and provide the received notification information to a user. For example, the device management application may manage (e.g., install, delete, update, and the like) functions for at least a part of the external electronic device (e.g., the other electronic device 104) communicating with the electronic device 101 (e.g., turning on/off the external electronic device itself (or some elements thereof) or adjusting the brightness (or resolution) of a display), applications operating in the external electronic device, or services (e.g., a telephone call service or a message service) provided from the external electronic device.

According to various embodiments of the present disclosure, the application 134 may include an application appointed according to the attribute (e.g., the type) of the external electronic device (e.g., the other electronic device 104). For example, in cases where the external electronic device is an MP3 player, the application 134 may include an application related to the reproduction of music. Similarly, in cases where the external electronic device is a mobile medical appliance, the application 134 may include an application related to health care. According to one embodiment of the present disclosure, the application 134 may include at least one of an application designated to the electronic device 101 and an application received from the external electronic device (e.g., a server 106 or the other electronic device 104).

The input/output interface 140 may transfer instructions or data input from a user through an input/output device (e.g., the sensor, a keyboard, a touch screen, and the like) to, for example, the processor 120, the memory 130, the communication interface 160, or the clipboard management module 170 through the bus 110. For example, the input/output interface 140 may provide, to the processor 120, data for a user's touch input through the touch screen. Furthermore, through the input/output device (e.g., a speaker, a display, and the like), the input/output interface 140 may output instructions or data received from the processor 120, the memory 130, the communication interface 160, or the clipboard management module 170 through the bus 110. For example, the input/output interface 140 may output voice data, processed through the processor 120, to a user through a speaker.

The display 150 may display various pieces of information (e.g., multimedia data, text data, and the like) to a user.

The communication interface 160 may connect communication between the electronic device 101 and the external electronic device (e.g., the other electronic device 104 or the server 106). For example, the communication interface 160 may be connected to a network 162 through wireless or wired communication to communicate with the external device. The wireless communication may include at least one of, for example, Wi-Fi (Wireless Fidelity), Bluetooth (BT), Near Field Communication (NFC), GPS and cellular communication (e.g., Long Term Evolution (LTE), LTE-A, Code Division Multiple Access (CDMA), Wideband CDMA (WCDMA), Universal Mobile Telecommunication System (UMTS), Wireless Broadband (WiBro), Global System for Mobile communication (GSM), and the like). The wired communication may include at least one of, for example, a Universal Serial Bus (USB), a High Definition Multimedia Interface (HDMI), Recommended Standard 232 (RS-232), a Plain Old Telephone Service (POTS), and the like.

According to one embodiment of the present disclosure, the network 162 may be a telecommunication network. The communication network may include at least one of a computer network, the Internet, a telephone network, and the like. According to one embodiment of the present disclosure, a protocol (e.g., a transport layer protocol, data link layer protocol, or a physical layer protocol) for communication between the electronic device 101 and the external device may be supported by at least one of the application 134, the API 133, the middleware 132, the kernel 131, and the communication interface 160.

According to an embodiment of the present disclosure, the clipboard management module 170 may control a clipboard function for, for example, a first program and a second program. According to an embodiment of the present disclosure, the clipboard management module 170 may perform an operation for converting clip data generated in the first program into data having a format related to the second program.

The clipboard management module 170 may generate a tag including information on a program having generated clip data and store the generated tag together with the clip data, and convert the clip data into data having a format related to the second program based on the tag information. The programs may be programs of different forms operating in the same operating system. According to another embodiment of the present disclosure, the programs may be different operating systems operated in the electronic device.

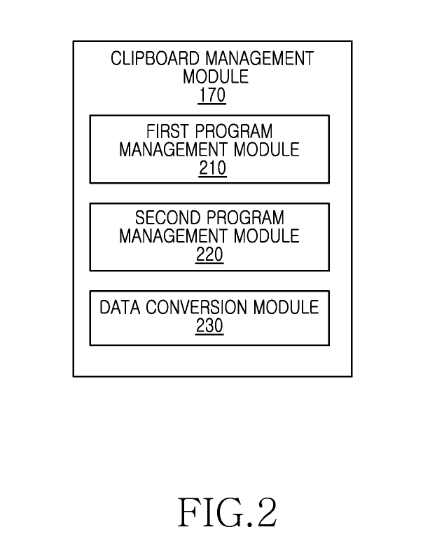

Additional information on the clipboard management module 170 will be provided through FIGS. 2 to 12 described below.

FIG. 2 illustrates a configuration of a clipboard management module according to an embodiment of the present disclosure.

Referring to FIG. 2, the clipboard management module (e.g., the clipboard management module 170 of FIG. 1) may include a first program management module 210, a second program management module 220, and a data conversion module 230.

The first program management module 210 may control the operation of the first program.

According to one embodiment of the present disclosure, the first program management module 210 may activate or deactivate a clipboard function for the first program under the control of the processor (e.g., processor 120 of FIG. 1). For example, the first program management module 210 may temporarily store selected information (e.g., table, mathematical expression, text, image, and the like) of the first program and then add the information to a program having the same format. According to an embodiment of the present disclosure, the first program management module 210 may add the selected information to another area of the first program.

According to various embodiments of the present disclosure, the first program management module 210 may generate tag information for clip data generated in the first program. The tag information may include at least one piece of information among information on the program having generated the clip data, data type, or data length.

The second program management module 220 may perform a similar operation to that of the first program management module 210. For example, the second program management module 220 may activate or deactivate a clipboard function for the second program. According to another embodiment of the present disclosure, the second program management module 220 may generate tag information for clip data generated in the second program.

The data conversion module 230 may convert the clip data generated in the first program or the second program. According to an embodiment of the present disclosure, the data conversion module 230 may convert the generated clip data in such a manner as to enable the clip data generated in the first program to be supported by the second program. According to one embodiment of the present disclosure, the first program may be a first operating system and the second program may be a second operating system. The first operating system and the second operating system may be different operating systems.

According to another embodiment of the present disclosure, the data conversion module 230 may convert clip data generated in the first program, using a markup language, such as Hyper Text Markup Language (HTML), eXtensible Markup Language (XML), Vector Markup Language (VML), Procedure Graphic Markup Language (PGML), or Scalable Vector Graphics (SVG), so as to allow the clip data to be used in the second program. The markup language refers to a language which expresses information on a logical structure and layout format of a document. The markup language does not refer to information on contents of a document, such as a sentence, a figure, a table, and sound included in the document, but refers to information on how the sentence, the figure, and the table are arranged and what size and shape the letters have, and information on indentation, line spacing, and margin.

According to another embodiment of the present disclosure, the clip data generated in the first program may be converted in an image rendering format.

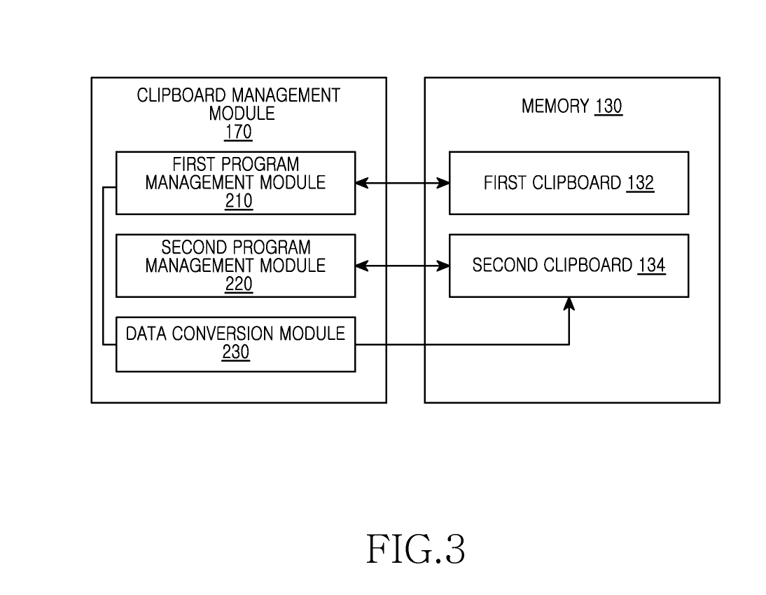

FIG. 3 illustrates an operation of a clipboard management module according to an embodiment of the present disclosure.

Referring to FIG. 3, description of parts equal or similar to those in FIG. 2 will be omitted.

The clipboard management module 170 (e.g., the clipboard management module 170 of FIG. 1) may include a first program management module 210, a second program management module 220, and a data conversion module 230. The first program management module 210 may temporarily store clip data in a first clipboard (e.g., the middleware 132) of a memory (e.g., the memory 130 of FIG. 1), and the second program management module 220 may temporarily store clip data in a second clipboard (e.g., the application 134 of the memory 130).

The data conversion module 230 may convert the clip data at a time point when data is stored in the clipboard. The time point when data is stored in the clipboard may be a time point when clip data is stored in the first clipboard 132 by the first program management module 210 or a time point when clip data is stored in the second clipboard 134 by the second program management module 220.

For example, when clip data is stored by the first program management module 210, the clip data (e.g., first clip data) stored in the first clipboard 132 may be converted so as to be usable in the second program management module 220, and the converted clip data (i.e., second clip data) may be processed so as to be stored in the second clipboard 134. The data conversion module 230 may provide the second clip data to the data conversion module 230 or directly store the second clip data in the second clipboard 134 by itself.

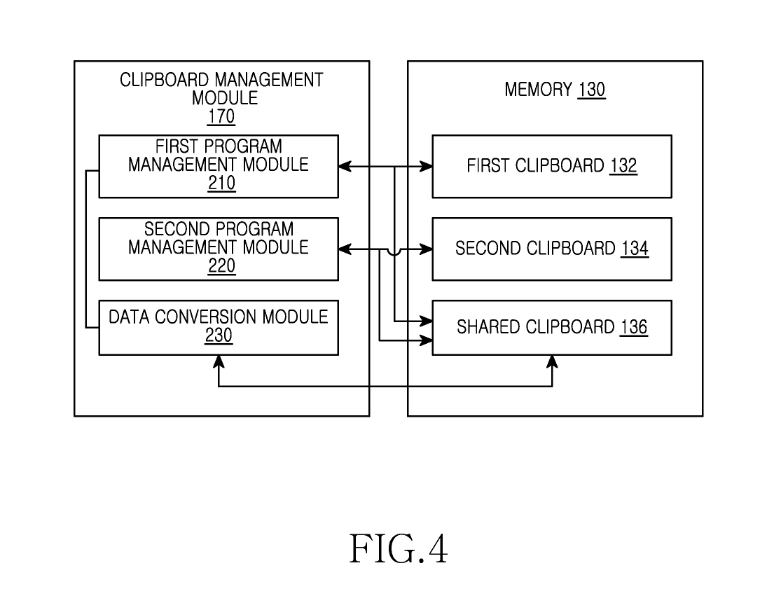

FIG. 4 illustrates an operation of a clipboard management module according to an embodiment of the present disclosure.

Referring to FIG. 4, description of parts equal or similar to those in FIG. 3 will be omitted.

The clipboard management module 170 (e.g., the clipboard management module 170 of FIG. 1) may include a first program management module 210, a second program management module 220, and a data conversion module 230. The first program management module 210 may temporarily store clip data in the first clipboard 132 of a memory (e.g., the memory 130 of FIG. 1), and the second program management module 220 may temporarily store clip data in the second clipboard 134 of the memory 130.

According to various embodiments of the present disclosure, the first program management module 210 and the second program management module 220 may temporarily store clip data in a shared clipboard 136. For example, the first program management module 210 may store clip data to be added within the same program in the first clipboard 132 while storing clip data to be added to another program in the shared clipboard 136. In the same manner, the second program management module 220 may manage clip data using the second clipboard 134 and the shared clipboard 136.

The data conversion module 230 may convert the clip data at the time point when data is stored in the shared clipboard 136.

For example, when clip data is stored in the shared clipboard 136 by the first program management module 210, the data conversion module 230 may convert the clip data (e.g., first clip data) stored in the shared clipboard 136 so as to be usable in the second program management module 220, and store the converted clip data (i.e., second clip data) in the shared clipboard 136. According to another embodiment of the present disclosure, the data conversion module 230 may store the converted clip data in the second clipboard 134 instead of the shared clipboard.

The data conversion module 230 may convert the clip data based on a tag for the clip data stored in the data conversion module 230.

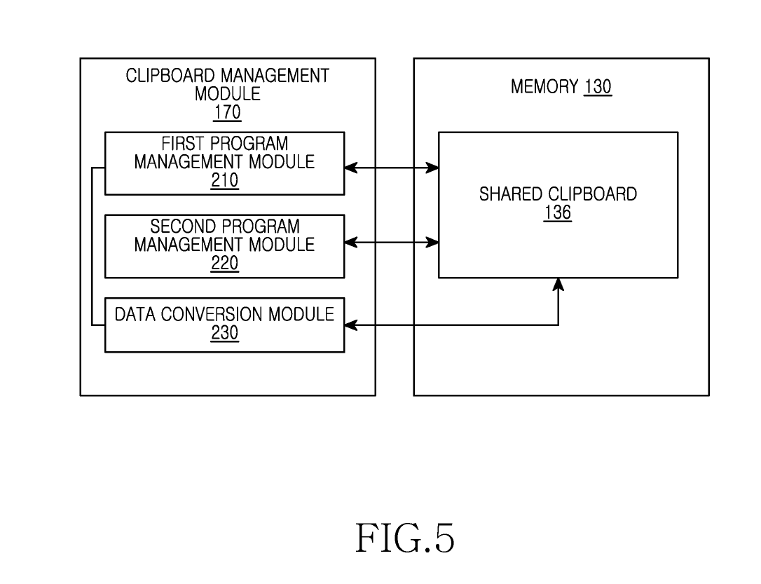

FIG. 5 illustrates an operation of a clipboard management module according to an embodiment of the present disclosure.

Referring to FIG. 5, description of parts equal or similar to those in FIG. 4 will be omitted.

The clipboard management module 170 (e.g., the clipboard management module 170 of FIG. 1) may include the first program management module 210, the second program management module 220, and the data conversion module 230. The first program management module 210 and the second program management module 220 may temporarily store clip data in the shared clipboard 136 in a memory (e.g., the memory 130 of FIG. 1).

According to various embodiments of the present disclosure, the first program management module 210 and the second program management module 220 may store clip data to be added within the same program and clip data to be added within another program in the shared clipboard 136.

The data conversion module 230 may convert the clip data at the time point when data is stored in the shared clipboard 136.

For example, when clip data is stored in the shared clipboard 136 by the first program management module 210, the data conversion module 230 may convert the clip data (e.g., first clip data) stored in the shared clipboard 136 so as to be usable in the second program management module 220, and store the converted clip data (i.e., second clip data) in the shared clipboard 136.

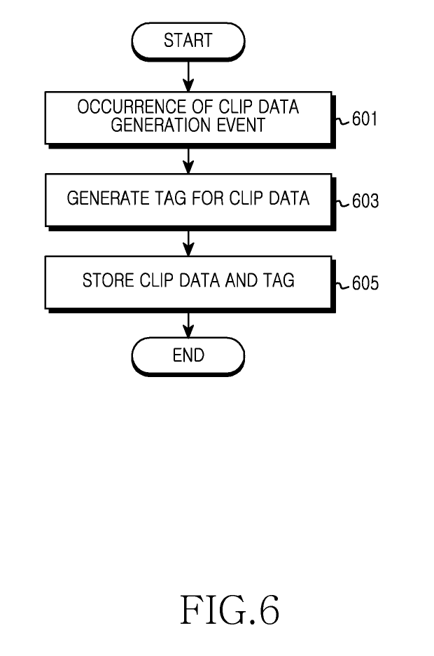

FIG. 6 is a flowchart illustrating an operation of an electronic device according to an embodiment of the present disclosure.

Referring to FIG. 6, different types of programs may be driven. According to one embodiment of the present disclosure, the programs may include operating systems and the electronic device may provide a clipboard function in a state where a first operating system and the second program are driven.

In operation 601, the electronic device may detect the occurrence of a clip data generation event. According to one embodiment of the present disclosure, the electronic device may detect selection of a menu for activating a clipboard function for adding, to the second operating system, information (e.g., text, image, table, mathematical expression, and the like) selected in the state where the first operating system is driven. According to one embodiment of the present disclosure, the clip data generation event may be activated through a copy or cut command.

In operation 603, the electronic device may generate a tag for the clipboard. In this event, according to the occurrence of a clip data generation event, the electronic device may temporarily store the selected information as clip data and then generate a tag for the temporarily stored clip data. The tag may include information (e.g., operating system information) on a program having generated the clip data, and information on data type (e.g., image, table, mathematical expression, text, and the like), data length, and the like.

In operation 605, the electronic device may store clip data and a tag.

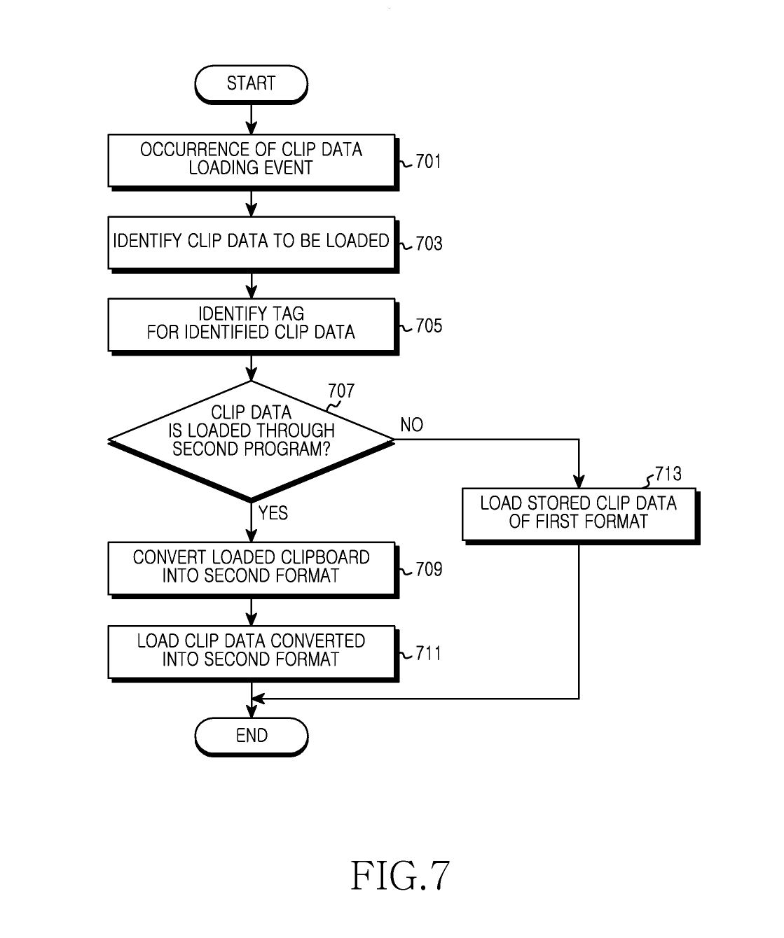

FIG. 7 is a flowchart illustrating an operation of an electronic device according to an embodiment of the present disclosure.

Referring to FIG. 7, different types of programs may be driven. According to one embodiment of the present disclosure, the programs may include operating systems and the electronic device may provide a clipboard function in a state where a first operating system and the second program are driven.

In operation 701, the electronic device may detect occurrence of a clip data loading event. The clip data loading event may be a request for adding clip data stored in a clipboard to a program. According to one embodiment of the present disclosure, the clip data loading event may be activated through a paste command.

In operation 703, the electronic device may identify clip data to be loaded. According to one embodiment of the present disclosure, the electronic device may output a clip data list and then identify clip data corresponding to a user input. According to another embodiment of the present disclosure, the electronic device may identify clip data associated with the output sequence based on the configuration of the clipboard. For example, when the clipboard is managed using a stack structure, the electronic device may define the most recently stored clip data as the clip data to be loaded.

In operation 705, the electronic device may identify a tag for the identified clip data.

In operation 707, the electronic device may determine, by identifying the tag for the clip data, whether the clip data is loaded through the second program. The second program may be a program having a format different from that of the program having generated the clip data. For example, when the clip data is generated in the first operating system the second program may be the second operating system.

In operation 709, when the clipboard is loaded through the second program, the electronic device may convert the loaded clipboard into a second format.

According to another embodiment of the present disclosure, the electronic device may convert the clip data into a format supported by the second program. For example, when the first program is an Android operating system while the second program is an Iphone™ operating system, the electronic device may convert the clip data generated in the Android operating system into a format satisfying the Iphone™ operating system.

According to another embodiment of the present disclosure, the electronic device may convert the clip data, using a highly compatible Markup language. For example, the electronic device may convert the clip data, using an XML.

According to another embodiment of the present disclosure, the electronic device may convert the clip data in an imager rendering scheme.

In operation 711, the electronic device may load the clip data converted into the second format and then add the clip data to the second program.

In operation 713, when the clipboard is loaded through the first program, the electronic device may load stored clip data of the first format and add the loaded clip data to the first program.

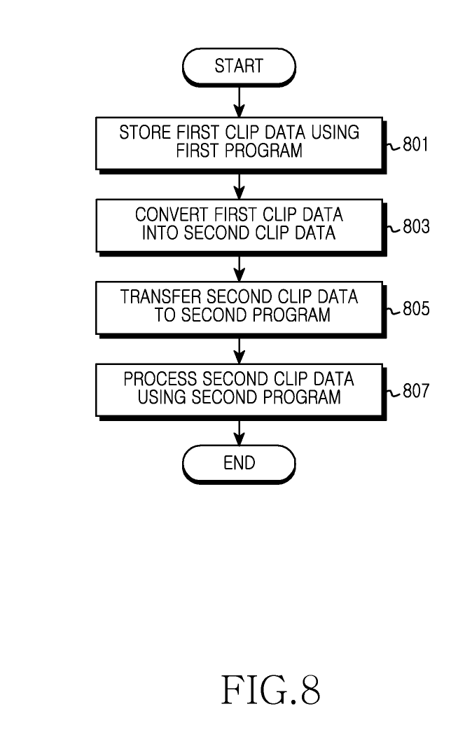

FIG. 8 is a flowchart illustrating an operation of an electronic device according to an embodiment of the present disclosure.

Referring to FIG. 8, different types of programs may be driven.

According to one embodiment of the present disclosure, the programs may include operating systems and the electronic device may provide a clipboard function in a state where a first operating system and the second program are driven. According to various embodiments of the present disclosure, the electronic device may convert the clip data using the first program.

In operation 801, the electronic device may store the first clip data in the clipboard, using the first program. Herein, the electronic device may store the first clip data in the clipboard of the first program.

In operation 803, the electronic device may convert the first clip data into the second clip data. Herein, the second clip data may be clip data having a format supported by the second program.

In operation 805, the second electronic device may transfer the second clip data to the second program.

In operation 807, the electronic device may process the second clip data using the second program.

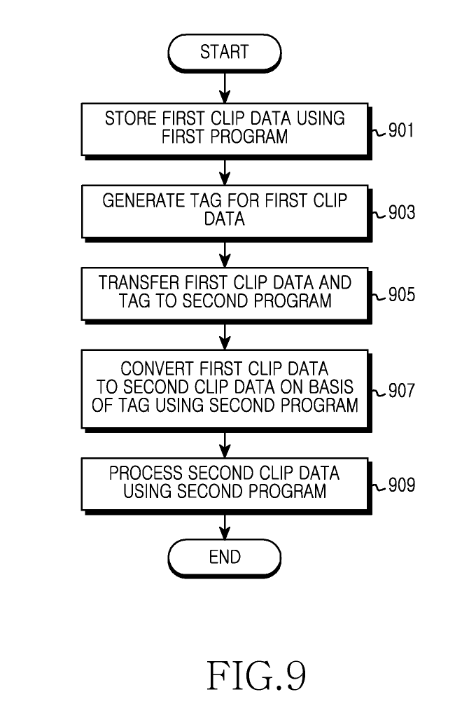

FIG. 9 is a flowchart illustrating an operation of an electronic device according to an embodiment of the present disclosure.

Referring to FIG. 9, different types of programs may be driven. According to one embodiment of the present disclosure, the programs may include operating systems and the electronic device may provide a clipboard function in a state where a first operating system and the second program are driven. According to various embodiments of the present disclosure, the electronic device may convert the clip data using the second program.

In operation 901, the electronic device may store the first clip data in the clipboard, using the first program. Herein, the electronic device may store the first clip data in the clipboard of the first program or a shared clipboard which the second program can access.

In operation 903, the electronic device may generate a tag for the first clip data. Herein, the tag may include information on the program having generated the clip data.

In operation 905, the electronic device may transfer the first clip data and the tag to the second program. Here, the second program may be a program driven within the electronic device. Further, according to another embodiment of the present disclosure, the second program may be a second electronic device separated from the electronic device.

In operation 907, the electronic device may convert the first clip data into the second clip data based on the tag using the second program. For example, when information on a program included in the tag of the first clip data does not coincide with the second program, the electronic device may convert the first clip data into the second clip data satisfying the format of the second program. In contrast, when information on a program included in the tag of the first clip data coincides with the second program, the electronic device may not convert the first clip data.

In operation 909, the electronic device may process the converted second clip data using the second program. For example, the electronic device may convert the first clip data generated in the first program to the second clip data and add the converted second clip data to the second program.

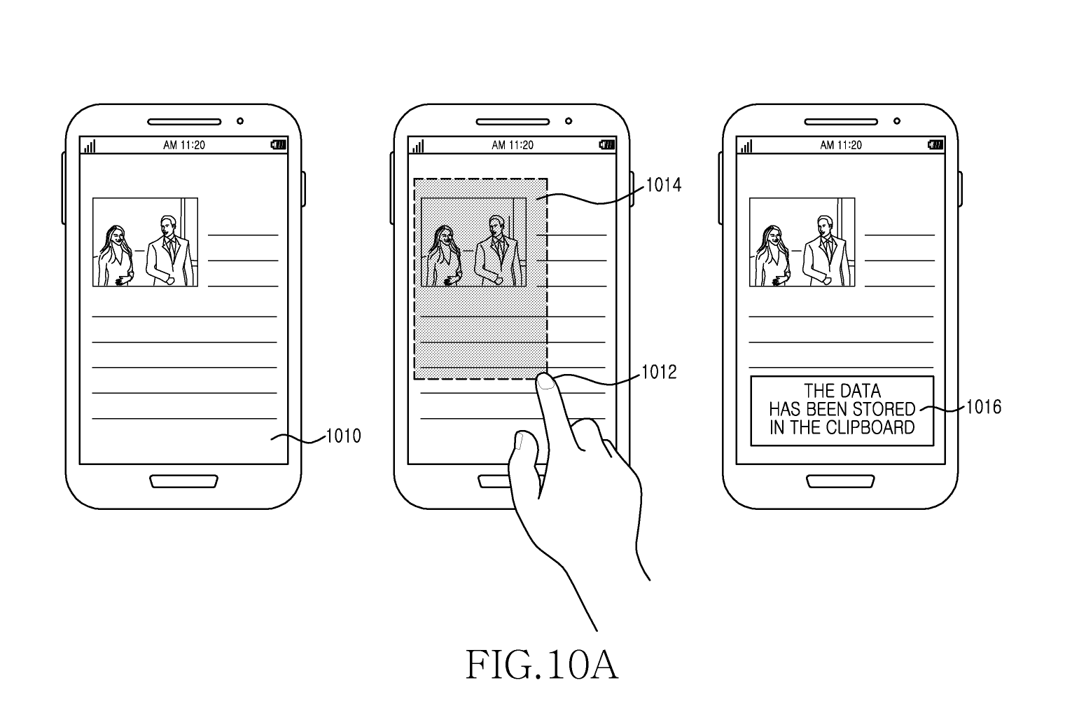

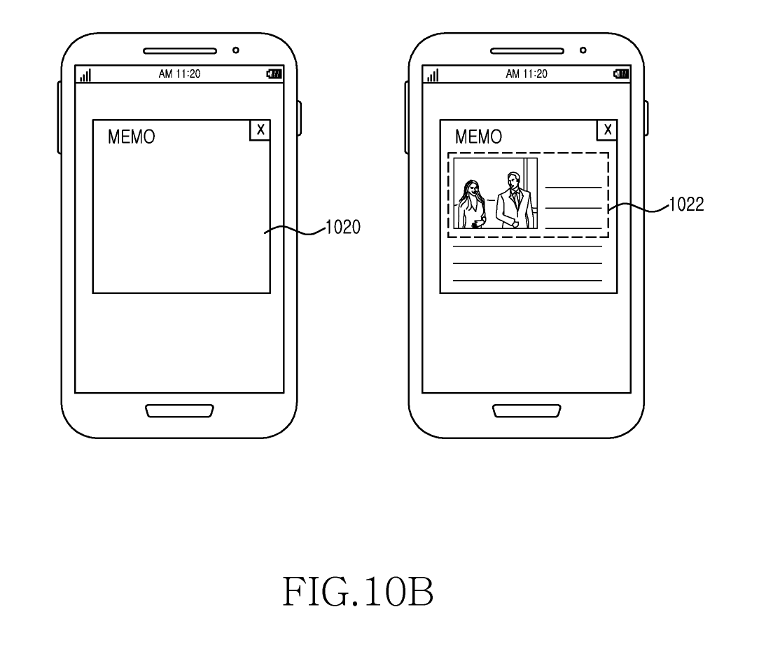

FIGS. 10A and 10B illustrate operations of an electronic device according to various embodiments of the present disclosure.

Referring to FIG. 10A, the electronic device may configure clip data through the first program (e.g., a web browser).

According to one embodiment of the present disclosure, the electronic device may detect an input 1012 for generating clip data in a state 1010 where the first program is executed. Here, the input may be an input appointing an area of the clip data. According to an embodiment of the present disclosure, the input may include a touch input and a drag input.

When the clip data 1014 is configured through the input as described above, the electronic device may temporarily store (1016) the clip data in the clipboard.

Referring to FIG. 10B, the electronic device may process, for example, paste the clip data through the second program.

As shown, the electronic device may detect an input for processing the clip data in a state 1020 where the second program (e.g., a memo program) is executed.

According to various embodiments of the present disclosure, the electronic device may convert the clip data generated by the first program into a format satisfying the second program and then add (1022) the converted clip data to the second program.

Referring to FIG. 10B, it is noted that the clip data generated by the first program has been converted so as to be suitable for the second program. In the illustrated figure, an image for conversion of the format is added in the middle of the text in order to help understanding thereof. According to various embodiments of the present disclosure, the format of the clip data is converted so as to enable programs of different formats to support the clip data.

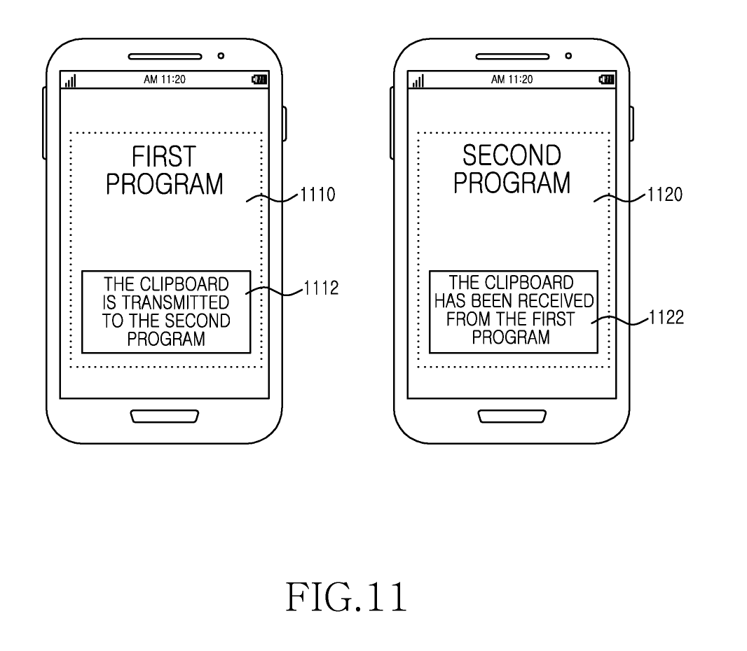

FIG. 11 illustrates an operation of an electronic device according to an embodiment of the present disclosure. In the description related to FIG. 11, description of parts equal or similar to those in FIG. 10 will be omitted.

Referring to FIG. 11, the electronic device may configure clip data through the first program (e.g., a web browser).

According to one embodiment of the present disclosure, the electronic device may generate clip data based on an input for generating the clip data in a state 1110 where the first program is executed.

According to various embodiments of the present disclosure, the electronic device may generate a tag for the generated clip data. The tag may include information on a program having generated the clip data.

According to various embodiments of the present disclosure, the electronic device may provide the generated clip data and tag to the second electronic device in which the second program is executed (1112).

The second electronic device may perform a clipboard function using the second program 1120 having received the clip data and the tag (1122).

According to one embodiment of the present disclosure, the electronic device may convert, using the second program, the clip data generated in the first program into a format which can be supported by the second program, and add the converted second clip data to the second program.

According to various embodiments of the present disclosure, a control method of an electronic device may include the operations of executing a first program, providing first clip data using a first program, converting the first clip data into second clip data associated with a second program, and processing the second clip data using the second program.

According to various embodiments of the present disclosure, the providing of the first clip data using the first program may include providing a tag for the first clip data.

According to various embodiments of the present disclosure, the tag may include information on the program having provided the first clip data.

According to various embodiments of the present disclosure, the converting of the first clip data into the second clip data associated with the second program may include converting the first clip data into the second clip data based on the tag.

According to various embodiments of the present disclosure, the second clip data may be converted using a markup language.

According to various embodiments of the present disclosure, the second clip data may be converted using an image rendering.

According to various embodiments of the present disclosure, either both the first program and the second program or only the first program may be allowed to access the area in which the first clip data is stored.

According to various embodiments of the present disclosure, the first program may include the first operating system and the second program may include the second operating system.

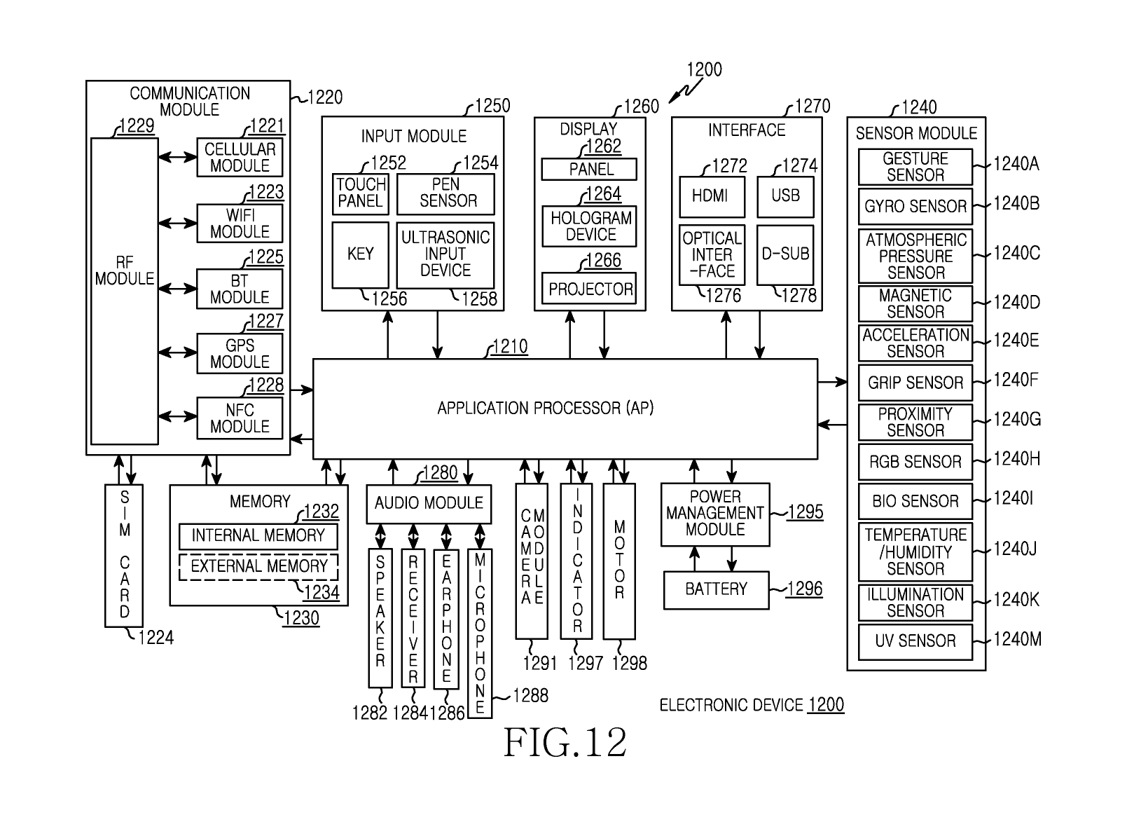

FIG. 12 is a block diagram of an electronic device according to an embodiment of the present disclosure. An electronic device 1200 may configure, for example, the whole or a part of the electronic device 101 illustrated in FIG. 1.

Referring to FIG. 12, the electronic device 1200 may include at least one Application Processor (AP) 1210, a communication module 1220, a Subscriber Identifier Module (SIM) card 1224, a memory 1230, a sensor module 1240, an input device 1250, a display 1260, an interface 1270, an audio module 1280, a camera module 1291, a power management module 1295, a battery 1296, an indicator 1297, and a motor 1298.

The AP 1210 may control a plurality of hardware or software elements connected to the AP 1210 by driving an operating system or an application program and process various types of data including multimedia data and perform calculations. The AP 1210 may be implemented by, for example, a System on Chip (SoC). According to one embodiment of the present disclosure, the AP 1210 may further include a Graphic Processing Unit (GPU).

The communication module 1220 (e.g., the communication interface 160) may perform data transmission/reception in communication between the electronic device 1200 (e.g., the electronic device 101) and other electronic devices (e.g., the electronic device 104 and the server 106) connected thereto through a network. According to an embodiment of the present disclosure, the communication module 1220 may include a cellular module 1221, a Wi-Fi module 1223, a BT module 1225, a GPS module 1227, an NFC module 1228, and a Radio Frequency (RF) module 1229.

The cellular module 1221 may provide a voice call, a video call, a SMS, or an Internet service through a communication network (e.g., LTE, LTE-A, CDMA, WCDMA, UMTS, WiBro, or GSM). Furthermore, the cellular module 1221 may distinguish and authenticate electronic devices within a communication network using, for example, a subscriber identification module (e.g., the SIM card 1224). According to one embodiment of the present disclosure, the cellular module 1221 may perform at least some functions which the AP 1210 may provide. For example, the cellular module 1221 may perform at least some of the multimedia control functions.

According to one embodiment of the present disclosure, the cellular module 1221 may include a Communication Processor (CP). Furthermore, the cellular module 1221 may be implemented by, for example, an SoC. Although the elements, such as the cellular module 1221 (e.g., a communication processor), the memory 1230, and the power management module 1295 are illustrated to be separate from the AP 1210 in FIG. 12, the AP 1210 may include at least some (e.g., the cellular module 1221) of the aforementioned elements in an embodiment.

According to an embodiment of the present disclosure, the AP 1210 or the cellular module 1221 (e.g., a communication processor) may load, in a volatile memory, a command or data received from at least one of a non-volatile memory and other elements connected thereto, and may process the loaded command or data. Furthermore, the AP 1210 or the cellular module 1221 may store data received from or generated by at least one of other elements in a non-volatile memory.

The Wi-Fi module 1223, the BT module 1225, the GPS module 1227, and the NFC module 1228 may include, for example, a processor for processing data transmitted/received through the corresponding module. In FIG. 12, the cellular module 1221, the WiFi module 1223, the BT module 1225, the GPS module 1227, and the NFC module 1228 are illustrated as separate blocks, but at least some (e.g., two or more) of the cellular module 1221, the WiFi module 1223, the BT module 1225, the GPS module 1227, and the NFC module 1228 may be included in one Integrated Chip (IC) or one IC package. For example, at least some (e.g., the communication processor corresponding to the cellular module 1221 and the Wi-Fi processor corresponding to the Wi-Fi module 1223) of the processors corresponding to the cellular module 1221, the Wi-Fi module 1223, the BT module 1225, the GPS module 1227, and the NFC module 1228 may be implemented by one SoC.

The RF module 1229 may transmit/receive data, for example, an RF signal. Although not illustrated, the RF module 1229 may include, for example, a transceiver, a Power Amp Module (PAM), a frequency filter, a Low Noise Amplifier (LNA) or the like. Further, the RF module 1229 may further include a component for transmitting/receiving electronic waves over a free air space in wireless communication, for example, a conductor, a conducting wire or the like. Although the cellular module 1221, the Wi-Fi module 1223, the BT module 1225, the GPS module 1227, and the NFC module 1228 share one RF module 1229 in FIG. 12, at least one of the cellular module 1221, the Wi-Fi module 1223, the BT module 1225, the GPS module 1227, and the NFC module 1228 may transmit/receive an RF signal through a separate RF module in one embodiment.

The SIM card 1224 may be a card including a subscriber identification module and may be inserted into a slot formed at a particular position of the electronic device. The SIM card 1224 may include unique identification information (e.g., an Integrated Circuit Card IDentifier (ICCID)) or subscriber information (e.g., International Mobile Subscriber Identity (IMSI)).

The memory 1230 (e.g., the memory 120) may include an internal memory 1232 or an external memory 1234. The internal memory 1232 may include, for example, at least one of a volatile memory (e.g., a Dynamic RAM (DRAM), a Static RAM (SRAM), a Synchronous Dynamic RAM (SDRAM)), and the like, and a non-volatile Memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a NAND flash memory, an NOR flash memory, and the like).

According to one embodiment of the present disclosure, the internal memory 1232 may be a Solid State Drive (SSD). The external memory 1234 may further include a flash drive, for example, a Compact Flash (CF), a Secure Digital (SD), a Micro Secure Digital (Micro-SD), a Mini Secure Digital (Mini-SD), an extreme Digital (xD), or a memory stick. The external memory 1234 may be functionally connected to the electronic device 1200 through various interfaces. According to one embodiment of the present disclosure, the electronic device 1200 may further include a storage device (or a storage medium), such as a hard disc drive.

The sensor module 1240 may measure a physical quantity or detect an operation state of the electronic device 1200 and convert the measured or detected information into an electronic signal. The sensor module 1240 may include at least one of, for example, a gesture sensor 1240A, a gyro sensor 1240B, an atmospheric pressure sensor 1240C, a magnetic sensor 1240D, an acceleration sensor 1240E, a grip sensor 1240F, a proximity sensor 1240G, a color sensor 1240H (e.g., red, green, and blue (RGB) sensor), a bio-sensor 1240I, a temperature/humidity sensor 1240J, an illumination sensor 1240K, and a Ultra Violet (UV) sensor 1240M. Additionally or alternatively, the sensor module 1240 may include, for example, an E-nose sensor (not illustrated), an electromyography (EMG) sensor (not illustrated), an electroencephalogram (EEG) sensor (not illustrated), an electrocardiogram (ECG) sensor (not illustrated), an Infrared (IR) sensor, an iris sensor (not illustrated), a fingerprint sensor, and the like. The sensor module 1240 may further include a control circuit for controlling at least one sensor involved therein.

The input device 1250 may include a touch panel 1252, a (digital) pen sensor 1254, a key 1256, or an ultrasonic input device 1258. The touch panel 1252 may recognize a touch input in at least one of, for example, a capacitive scheme, a resistive scheme, an infrared scheme, and an acoustic wave scheme. Further, the touch panel 1252 may further include a control circuit. In the case of the capacitive type, physical contact or proximity recognition is possible. The touch panel 1252 may further include a tactile layer. In this event, the touch panel 1252 may provide a tactile response to the user.

The (digital) pen sensor 1254 may be implemented, for example, using the same or a similar method to receiving a user's touch input or using a separate recognition sheet. The key 1256 may include, for example, a physical button, an optical key, or a keypad. The ultrasonic input device 1258 may identify data by detecting an acoustic wave with a microphone (e.g., a microphone 1288) of the electronic device 1200 through an input unit generating an ultrasonic signal, and may perform wireless recognition. According to an embodiment of the present disclosure, the electronic device 1200 may receive a user input from an external device (e.g., a computer, a server, and the like) connected thereto using the communication module 1220.

The display 1260 (e.g., the display 150) may include a panel 1262, a hologram device 1264, or a projector 1266. The panel 1262 may be, for example, a Liquid Crystal Display (LCD) and an Active Matrix Organic Light Emitting Diode (AM-OLED) display, and the like. The panel 1262 may be implemented so as to be, for example, flexible, transparent, or wearable. The panel 1262 may be integrated with the touch panel 1252 to configure one module. The hologram device 1264 may show a stereoscopic image in the air using interference of light. The projector 1266 may project light onto a screen to display an image. The screen may be located, for example, inside or outside the electronic device 1200. According to one embodiment of the present disclosure, the display 1260 may further include a control circuit for controlling the panel 1262, the hologram device 1264, or the projector 1266.

The interface 1270 may include, for example, a High-Definition Multimedia Interface (HDMI) 1272, a USB 1274, an optical interface 1276, or a D-subminiature (D-sub) 1278. The interface 1270 may be included in, for example, the communication interface 160 illustrated in FIG. 1. Additionally or alternatively, the interface 1270 may include, for example, a Mobile High-definition Link (MHL) interface, a Secure Digital (SD)/Multi-Media Card (MMC) interface, or an Infrared Data Association (IrDA) standard interface.

The audio module 1280 may bilaterally convert a sound and an electronic signal. At least some elements of the audio module 1280 may be included in, for example, the input/output interface 140 illustrated in FIG. 1. The audio module 1280 may process sound information input or output through, for example, a speaker 1282, a receiver 1284, earphones 1286, or a microphone 1288.

The camera module 1291 is a device for capturing a still image or a video, and according to an embodiment of the present disclosure, may include one or more image sensors (e.g., a front sensor, a rear sensor, and the like), a lens (not illustrated), an Image Signal Processor (ISP) (not illustrated), or a flash (not illustrated) (e.g., an LED or xenon lamp).

The power management module 1295 may manage power of the electronic device 1200. Although not illustrated, the power management module 1295 may include, for example, a Power Management Integrated Circuit (PMIC), a charger Integrated Circuit (IC), or a battery or fuel gauge.

The PMIC may be mounted, for example, in integrated circuits or SoC semiconductors. The charging methods may be divided into a wired type and a wireless type. The charger IC may charge a battery and prevent inflow of excessive voltage or excessive current from a charger. According to an embodiment of the present disclosure, the charger IC may include a charger IC for at least one of the wired charging type or the wireless charging type. The wireless charging method may include, for example, a magnetic resonance scheme, a magnetic induction scheme, or an electromagnetic scheme, and may further include an additional circuit for wireless charging, such as a coil loop, a resonance circuit, or a rectifier circuit.

The battery gauge may measure, for example, a residual quantity of the battery 1296, or a voltage, a current, or a temperature during the charging. The battery 1296 may store or generate electricity, and may supply power to the electronic device 1200 using the stored or generated electricity. The battery 1296 may include, for example, a rechargeable battery or a solar battery.

The indicator 1297 may display a specific status of the electronic device 1200 or a part (e.g., the AP 1210) of electronic device, for example, a booting status, a message status, a charging status, and the like. The motor 1298 can convert an electrical signal into a mechanical vibration. Although not illustrated, the electronic device 1200 may include a processing unit (e.g., a GPU) for supporting mobile TV. The processing device for supporting mobile TV may process media data according to standards, such as, for example, a Digital Multimedia Broadcasting (DMB), a Digital Video Broadcasting (DVB), a media flow, and the like.

Each of the components of the electronic device according to the present disclosure may be implemented by one or more components and the name of the corresponding component may vary depending on the type of the electronic device. The electronic device according to the present disclosure may be configured by including at least one of the above-described elements, and some of the elements may be omitted, or other elements may be added. Further, some of the elements of the electronic device according to the present disclosure may be combined to be one entity, which can perform the same functions as those of the components before the combination.

According to various embodiments of the present disclosure, an electronic device may include a memory including a clipboard for a first program, and a first program management module for generating clip data and a tag of the first program and providing the generated clip data and tag to a second program.

According to various embodiments of the present disclosure, the second program may include a second electronic device.

According to various embodiments of the present disclosure, the electronic device may include a data conversion module for converting the received clip data into second clip data associated with the second program based on the received tag.

According to various embodiments of the present disclosure, the second program may include a second operating system.

According to various embodiments of the present disclosure, the second electronic device may include a data conversion module for, when second clip data and a tag are received from the second program, converting the second clip data into first clip data associated with the first program.

According to various embodiments of the present disclosure, the first program may include a first operating system.

The term “module” used in the present disclosure may refer to, for example, a unit including one or more combinations of hardware, software, and firmware. The “module” may be interchangeably used with a term, such as unit, logic, logical block, component, or circuit. The “module” may be the smallest unit of an integrated component or a part thereof. The “module” may be the smallest unit that performs one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments of the present disclosure, at least some of the devices (e.g., modules or functions thereof) or the method (e.g., operations) according to the present disclosure may be implemented by a command stored in a computer-readable storage medium in a programming module form. When the command is executed by one or more processors (e.g., the processor 120), the one or more processors may execute a function corresponding to the command. The computer-readable storage medium may be, for example, the memory 130. At least a part of the programming module may be implemented (e.g., executed) by, for example, the processor 120. At least some of the programming modules may include, for example, a module, a program, a routine, a set of instructions or a process for performing one or more functions.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a ROM, a RAM, Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

According to various embodiments of the present disclosure, a storage medium that stores commands is provided. The commands are configured to allow one or more processors to perform one or more operations when the commands are executed by the one or more processors. The one or more operations may include an operation of executing a first program, an operation of providing first clip data using a first program, an operation of converting the first clip data into second clip data associated with a second program, and an operation of processing the second clip data using the second program.

A method and an apparatus for controlling an electronic device according to various embodiments of the present disclosure can convert, for example, clip data generated in the first program so as to be suitable for the format of the second program, and can provide a clipboard function between different programs.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A control method of an electronic device, the method comprising:
executing a first program;
providing first clip data based on the first program;
converting the first clip data into second clip data associated with a second program; and
processing the second clip data based on the second program.

2. The method of claim 1, wherein the providing of the first clip data based on the first program comprises providing a tag for the first clip data.

3. The method of claim 2, wherein the tag comprises information on a program having provided the first clip data.

4. The method of claim 2, wherein the converting of the first clip data into the second clip data associated with the second program comprises converting the first clip data into the second clip data based on the tag.

5. The method of claim 1, wherein the second clip data is converted based on a markup language.

6. The method of claim 1, wherein the second clip data is converted based on an image rendering.

7. The method of claim 1, wherein the first program is allowed to access an area in which the first clip data is stored.

8. The method of claim 1, wherein the first program comprises a first operating system and the second program comprises a second operating system.

9. An electronic device comprising:
a memory configured to store a clipboard for a first program; and
a first program management module configured:
to generate clip data and a tag of the first program, and
to provide the generated clip data and tag to a second program.

10. The electronic device of claim 9, wherein the second program comprises a second electronic device.

11. The electronic device of claim 10, wherein the second electronic device comprises a data conversion module configured to convert received clip data into second clip data associated with the second program based on a received tag.

12. The electronic device of claim 10, wherein the second program comprises a second operating system.

13. The electronic device of claim 9, wherein the electronic device comprises a data conversion module configured to, when receiving second clip data and a tag from the second program, convert the second clip data into first clip data associated with the first program.

14. The electronic device of claim 11, wherein the second clip data is converted based on a markup language.

15. The electronic device of claim 11, wherein the second clip data is converted based on an image rendering.

16. The electronic device of claim 13, wherein the first program is allowed to access an area in which the first clip data is stored.

17. The electronic device of claim 9, wherein the first program comprises a first operating system.

18. At least one non-transitory processor readable medium for storing a computer program of instructions configured to be readable by at least one processor for instructing the at least one processor to execute a computer process for performing the method as recited in claim 1.
